(19) United States
(12) Patent Application Publication
(10) Pub. No.: US 2016/0103817 A1
(43) Pub. Date: Apr. 14, 2016

(54) Method, device and system for electronic stamping

(71) Applicant: Tianjin Sursen Investment Co., Ltd., Tianjin (CN)

(72) Inventor: Donglin WANG, Tianjin (CN)

(21) Appl. No.: 14/973,137

(22) Filed: Dec. 17, 2015

Related U.S. Application Data
(63) Continuation of application No. PCT/CN2014/079686, filed on Jun. 11, 2014.

(30) Foreign Application Priority Data
Jun. 17, 2013 (CN) 201310238842/6

(51) Int. Cl. G06F 17/24; G06F 3/0488

(52) U.S. Cl. CPC G06F 17/241; G06F 3/0488

(57) ABSTRACT

A method for electronic stamping comprises: receiving a touching event of a touchscreen and position information indicating a position on the touchscreen where the touching event occurs; receiving a stamping event of an electronic stamping device; retrieving a stamp image and electronic stamping authentication information from the electronic stamping device after receiving, in a predefined time period, the touching event of the touchscreen and the stamping event of the electronic stamping device; and determining a stamping position based on the position information indicating the position on the touchscreen where the touching event occurs, and executing electronic stamping at the determined stamping position based on the stamp image and the electronic stamping authentication information. An electronic stamping device and a stamping apparatus are also disclosed.

### CROSS-REFERENCE TO RELATED APPLICATIONS

The present application is a continuation of International Patent Application No. PCT/CN2014/079686 filed on Jun. 11, 2014, which claims priority of Chinese Patent Application No. 201310238842.6 filed on Jun. 17, 2013, and is also a continuation in part of U.S. patent application Ser. No. 14/386,521 filed on Sep. 19, 2014, which is a continuation of International Patent Application No. PCT/CN2012/075795 filed on May 21, 2012, which claims priority of Chinese Patent Application No. 201210074401.2 filed on Mar. 20, 2012, the contents of which are incorporated by reference herein in their entirety.

### TECHNICAL FIELD

Aspects of the present invention relate to electronic stamping technology, and more particularly to a method, device and system for electronic stamping.

### BACKGROUND

Electronic stamping technology is used to simulate traditional physical stamps using advanced digital technology. An electronic file sealed by an electronic stamp has the substantially same appearance and effectiveness as a paper file sealed by a physical stamp.

Currently the electronic stamp is generally implemented using Ukey. When a Ukey is connected to a computer or another electronic device through a USB port, a stamping image stored in the Ukey is read, a position to be sealed is selected by a mouse or another input device or is fixed by a configuration program, and then electronic stamping is implemented on the position. Although this method has good effectiveness, the operation is complicated and the operation experience is much different from the traditional stamping.

### BRIEF DESCRIPTION OF DRAWINGS

FIG. 1 is a schematic view illustrating a system for electronic stamping according to an example embodiment of the present invention.

FIG. 2 is a flowchart illustrating a method for electronic stamping according to an example embodiment of the present invention.

FIG. 3 is a schematic view illustrating a stamping apparatus according to an example embodiment of the present invention.

FIG. 4 is a schematic view illustrating an electronic stamping device according to an example embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

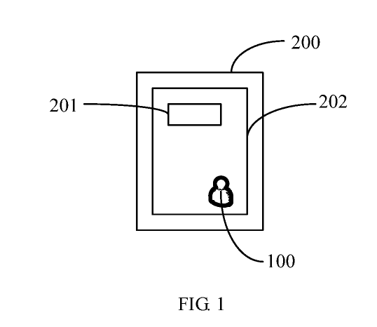

Embodiments of the present invention provide a method, device and system for electronic stamping which can bring similar operation experience as traditional stamping with a physical stamp. Hereinafter the method, device and system for electronic stamping will be described in detail with reference to FIGS. 1-4.

FIG. 1 is a schematic view illustrating a system for electronic stamping according to an example embodiment of the present invention.

As shown in FIG. 1, an electronic stamping system according to an example embodiment of the present invention comprises an electronic stamping device 100 and a client device 200. The client device 200 comprises a stamping apparatus 201 and a touchscreen 202. The electronic stamping device 100 stores a stamp image and electronic stamping authentication information.

After a bottom end of the electronic stamping device 100 contacts the touchscreen 202 of the client device 200, a touching event of the touchscreen 202 is triggered, and a stamping event of the electronic stamping device 100 is triggered. Here, triggering of the touching event is caused by contact of the touchscreen 202, and an operation system of the client device 200 informs the stamping apparatus 201 of the touching event, while triggering of the stamping event is caused by contact of the bottom end of the electronic stamping device 100, and the electronic stamping device 100 informs the stamping apparatus 201 of the stamping event.

After receiving the touching event and the stamping event in a certain time period, for example a predetermined time period, the stamping apparatus 201 achieves the stamp image and the electronic stamping authentication information from the electronic stamping device 100, and seals an electronic stamp at the position where the touching event occurs.

Here, Radio Frequency (RF) near field communication or Bluetooth communication can be used as the communication between the electronic stamping device 100 and the stamping apparatus 201.

Those skilled in the art can appreciate that a touching event is constituted of three actions: a touching start (TOUCH-DOWN), a touching moving (TOUCH-MOVE) and a touching end (TOUCH-UP).

In one embodiment of the present invention, the electronic stamping device 100 records amplitude of the pressure sensitivity and transfers pressure sensitivity information indicating the amplitude of the pressure sensitivity to the stamping apparatus 201. The stamping apparatus 201 adjusts depths of color of the stamping image displaying at the stamping position based on the pressure sensitivity information. Alternatively, the pressure sensitivity information can be recorded by the stamping apparatus 201 directly.

Those skilled in the art will understand that the stamping apparatus 201 may be implemented by physical hardware, or software, or combination of hardware and software. The software may be a program installed in the client device 200 which can implement the above-described functions of the stamping apparatus 201.

The electronic stamping device 100 is a physical device having a similar appearance as a traditional stamp which is made of wood or plastic. The electronic stamping device 100 comprises electronic hardware including interfaces used for communication with outside environments. For example, the interfaces can be used to receive control commands, a stamp image and electronic stamping authentication information, and the like. The structure of the electronic stamping device 100 will be described in detail later.

With the system for electronic stamping according to embodiments of the present invention, electronic stamping can be made to a document shown in the client device by using cooperation of the electronic stamping device and the client device, and the usage of the electronic stamping device is similar to that of the traditional physical stamps, therefore the usage is simple and operation experience is good.

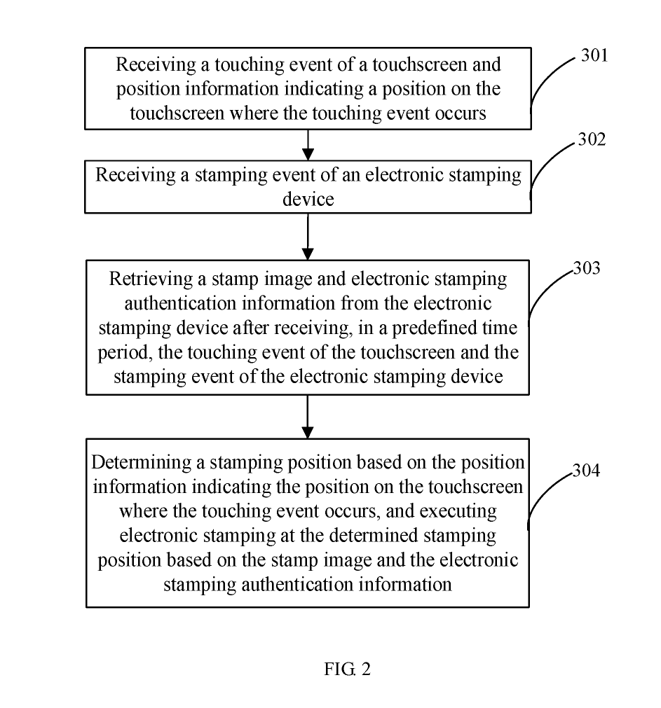

FIG. 2 is a flowchart illustrating a method for electronic stamping according to an example embodiment of the present invention.

As shown in FIG. 2, a method for electronic stamping according to an example embodiment comprises:

Step 301: receiving a touching event of a touchscreen and position information indicating a position on the touchscreen where the touching event occurs;

Step 302: receiving a stamping event of an electronic stamping device;

Step 303: retrieving a stamp image and electronic stamping authentication information from the electronic stamping device after receiving, in a predefined time period, the touching event of the touchscreen and the stamping event of the electronic stamping device; and

Step 304: determining a stamping position based on the position information indicating the position on the touchscreen where the touching event occurs, and executing electronic stamping at the determined stamping position based on the stamp image and the electronic stamping authentication information.

Those skilled in the art can appreciate that the order of Steps 301 and 302 may be interchanged. In addition, the predefined time period is adjustable, that is, it can be changed.

In one example embodiment of the present invention, the touching event of the touchscreen is an event triggered by the touchscreen after the touchscreen is touched, for example by the electronic stamping device. The stamping event of the electronic stamping device is an event triggered after the electronic stamping device is contacted, for example with the touchscreen.

In one example embodiment of the present invention, if any or both of the touching event of the touchscreen and the stamping event of the electronic stamping device is not received in a certain time period, for example a predefined time period, Steps 303 and 304 will not be implemented, that is, the electronic stamping will fail.

In an example embodiment of the present invention, the method further comprises: receiving pressure sensitivity information indicating an amplitude of pressure sensitivity of contact between the electronic stamping device and the touchscreen from the electronic stamping device; and adjusting depths of color of the stamping image displaying at the stamping position based on the pressure sensitivity information.

Alternatively, the method further comprises: recording pressure sensitivity information indicating an amplitude of pressure sensitivity of contact between the electronic stamping device and the touchscreen; and adjusting depths of color of the stamping image displaying at the stamping position based on the pressure sensitivity information.

In an example embodiment of the present invention, before retrieving a stamp image and electronic stamping authentication information from the electronic stamping device, the method may further comprise a step of authenticating the electronic stamping device, that is, verifying whether the electronic stamping device is a legal electronic stamping device. For example, a unique identification number can be assigned to an electronic stamping device and the identification number can be carried in the stamping event. If the electronic stamping device is a registered one, the identification number of the electronic stamping device can be found in a registration table, and it can be determined that the electronic stamping device is a legal one. In contrast, if the identification number of the electronic stamping device cannot be found in the registration table, it can be determined that the electronic stamping device is not a legal one. It can be understood that the above-mentioned method using the identification number is just an example and is not intended to limit the present invention.

In an example embodiment of the present invention, the stamping event of the electronic stamping device is received through RF near field communication or Bluetooth communication.

With the method for electronic stamping according to embodiments of the present invention, electronic stamping can be made to a document shown in the client device by using cooperation of the electronic stamping device and the client device, and the usage of the electronic stamping device is similar to that of the traditional physical stamps, therefore the usage is simple and operation experience is good.

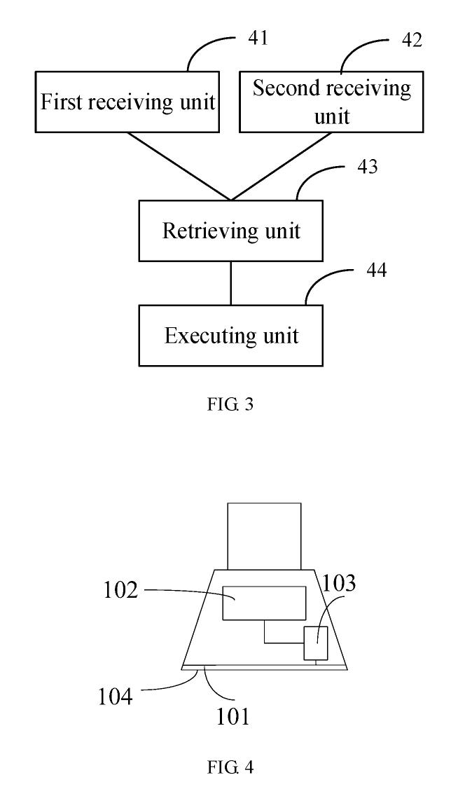

FIG. 3 is a schematic view illustrating a stamping apparatus according to an example embodiment of the present invention.

As shown in FIG. 3, a stamping apparatus according to an example embodiment of the present invention comprises: a first receiving unit 41 for receiving a touching event of a touchscreen and position information indicating a position on the touchscreen where the touching event occurs; a second receiving unit 42 for receiving a stamping event of an electronic stamping device; a retrieving unit 43 for retrieving a stamp image and electronic stamping authentication information from the electronic stamping device after receiving, in a predefined time period, the touching event of the touchscreen and the stamping event of the electronic stamping device; and an executing unit 44 for determining a stamping position based on the position information indicating the position on the touchscreen where the touching event occurs, and executing electronic stamping at the determined stamping position based on the stamp image and the electronic stamping authentication information.

In one example embodiment of the present invention, the touching event of the touchscreen is an event triggered by the touchscreen after the touchscreen is touched, for example by the electronic stamping device. The stamping event of the electronic stamping device is an event triggered after the electronic stamping device is contacted, for example with the touchscreen.

In one example embodiment of the present invention, the stamping apparatus may further comprises: a third receiving unit for receiving pressure sensitivity information indicating an amplitude of pressure sensitivity of contact between the electronic stamping device and the touchscreen, for example from the electronic stamping device; and an adjusting unit for adjusting depths of color of the stamping image displaying at the stamping position based on the pressure sensitivity information.

Alternatively, the stamping apparatus may further comprises: a recording unit for recording pressure sensitivity information indicating an amplitude of pressure sensitivity of contact between the electronic stamping device and the touchscreen; and an adjusting unit for adjusting depths of color of the stamping image displaying at the stamping position based on the pressure sensitivity information.

With the stamping apparatus according to embodiments of the present invention, electronic stamping can be made to a document shown in the client device by using cooperation of the electronic stamping device and the client device, and the usage of the electronic stamping device is similar to that of the traditional physical stamps, therefore the usage is simple and operation experience is good.

FIG. 4 is a schematic view illustrating an electronic stamping device according to an example embodiment of the present invention.

As shown in FIG. 4, an electronic stamping device according to an example embodiment of the present invention comprises a pressure sensor 101, a memory 102 and a communication interface 103 connected to the pressure sensor 101 and the memory 102.

The memory 102 stores a stamp image and electronic stamping authentication information. After the electronic stamping device contacts a client device, the pressure sensor 101 triggers a stamping event and transfers the stamping event to the communication interface 103. The communication interface 103 transfers the stamping event to the client device. The client device sends a request to the electronic stamping device after receiving, for example in a predetermined time period, a touching event from a touchscreen of the client device and the stamping event from the electronic stamping device. After receiving the request from the client device, the communication interface 103 retrieves the stamp image and the electronic stamping authentication information, and then transfer the same to the client device.

In an example embodiment of the present invention, the stamp image and the electronic stamping authentication information stored in the memory 102 can be deleted, updated or changed through the communication interface 103 by a user of the client device.

In an example embodiment of the present invention, the pressure sensor 101 further records pressure sensitivity information indicating an amplitude of pressure sensitivity of contact between the electronic stamping device and the touchscreen of the client device, and transfers the pressure sensitivity information to the client device through the communication interface 103, so that the client device can adjust depths of color of the stamping image displaying at the stamping position based on the pressure sensitivity information.

In an example embodiment of the present invention, the communication interface uses RF near field communication or Bluetooth communication to communicate with the client device.

In an example embodiment of the present invention, the electronic stamping device may further comprise: a contact surface to be contacted with the touchscreen of the client device; a closed space with the contact surface as the bottom surface; and a handle connected to the other side of the closed space opposing to the contact surface. The material of the contact surface may be determined according to the performance of the touchscreen. For example, if only contact similar to skin can be recognized by the touchscreen, the contact surface may be made of a material similar to skin. In addition, the closed space can be replaced with a half-open space. The handle is similar to a handle of a physical stamp, so that the user can perform electronic stamping using the handle, which brings similar operation experience as the traditional stamps.

In an example embodiment of the present invention, the electronic stamping device may further comprise an impression image 104. The impression image 104 may be disposed at a bottom end of the electronic stamping device, that is, the contacting surface to be contacted with the touchscreen of the client device. The impression image 104 may comprise an image which is the same as or similar to the stamp image stored in the memory 102, so that the user can have operation experience which is more intuitive.

The impression image 104 may be adhered on the outside of the contact surface, the pressure sensor 101 and the memory 102 may be located within the space with the contact surface as the bottom surface. The communication interface 103 may be located within the space also and can communicate with outside in a wireless way. Alternatively, in the case that the space is a half-open space, the memory and the pressure sensor are located within the space, while the communication interface can cross the space, that is a part thereof is within the space and the other part thereof is outside the space.

With the electronic stamping device according to embodiments of the present invention, electronic stamping can be made to a document shown in the client device by using cooperation of the electronic stamping device and the client device, and the usage of the electronic stamping device is similar to that of the traditional physical stamps, therefore the usage is simple and operation experience is good.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A method for electronic stamping, comprising:
receiving a touching event of a touchscreen and position information indicating a position on the touchscreen where the touching event occurs;
receiving a stamping event of an electronic stamping device;
retrieving a stamp image and electronic stamping authentication information from the electronic stamping device after receiving, in a predefined time period, the touching event of the touchscreen and the stamping event of the electronic stamping device; and
determining a stamping position based on the position information indicating the position on the touchscreen where the touching event occurs, and executing electronic stamping at the determined stamping position based on the stamp image and the electronic stamping authentication information.

2. The method of claim 1, wherein the predefined time period is adjustable.

3. The method of claim 1, further comprising:
receiving pressure sensitivity information indicating an amplitude of pressure sensitivity of contact between the electronic stamping device and the touchscreen from the electronic stamping device; and
adjusting depths of color of the stamping image displaying at the stamping position based on the pressure sensitivity information.

4. The method of claim 1, further comprising:
recording pressure sensitivity information indicating an amplitude of pressure sensitivity of contact between the electronic stamping device and the touchscreen; and
adjusting depths of color of the stamping image displaying at the stamping position based on the pressure sensitivity information.

5. The method of claim 1, before retrieving a stamp image and electronic stamping authentication information from the electronic stamping device, further comprising verifying whether the electronic stamping device is a legal electronic stamping device.

6. The method of claim 1, wherein the stamping event of the electronic stamping device is received through RF near field communication or Bluetooth communication.

7. An electronic stamping device, comprising:
a memory for storing a stamp image and electronic stamping authentication information;
a pressure sensor for triggering a stamping event after the electronic stamping device contacts a client device; and
a communication interface for receiving the stamping event from the pressure sensor and transferring the stamping event to the client device, and retrieving the stamp image and the electronic stamping authentication information from the memory and then transferring the stamp image and the electronic stamping authentication information to the client device after receiving a request from the client device.

8. The electronic stamping device of claim 7, wherein the pressure sensor further records pressure sensitivity information indicating an amplitude of pressure sensitivity of contact between the electronic stamping device and a touchscreen of the client device, and transfers the pressure sensitivity information to the client device through the communication interface.

9. The electronic stamping device of claim 7, wherein the communication interface uses RF near field communication or Bluetooth communication.

10. The electronic stamping device of claim 7, further comprising a contact surface to be contacted with a touchscreen of the client device and an impression image adhered on the contact surface.

11. The electronic stamping device of claim 10, further comprising a space with the contact surface as a bottom surface.

12. The electronic stamping device of claim 11, wherein the space is a closed space, the memory, the pressure sensor and the communication interface are located within the space.

13. The electronic stamping device of claim 11, wherein the space is a half-opened space, the memory, the pressure sensor and a part of the communication interface are located within the space, and the other part of the communication interface is located outside the space.

14. The electronic stamping device of claim 11, further comprising a handle connected to the other side of the space opposing to the contact surface.

15. A stamping apparatus, comprising:
a first receiving unit for receiving a touching event of a touchscreen and position information indicating a position on the touchscreen where the touching event occurs;
a second receiving unit for receiving a stamping event of an electronic stamping device;
a retrieving unit for retrieving a stamp image and electronic stamping authentication information from the electronic stamping device after receiving, in a predefined time period, the touching event of the touchscreen and the stamping event of the electronic stamping device; and
an executing unit for determining a stamping position based on the position information indicating the position on the touchscreen where the touching event occurs, and executing electronic stamping at the determined stamping position based on the stamp image and the electronic stamping authentication information.

16. The stamping apparatus of claim 15, further comprising:
a third receiving unit for receiving pressure sensitivity information indicating an amplitude of pressure sensitivity of contact between the electronic stamping device and the touchscreen from the electronic stamping device; and
an adjusting unit for adjusting depths of color of the stamping image displaying at the stamping position based on the pressure sensitivity information.

17. The stamping apparatus of claim 15, further comprising:
a recording unit for recording pressure sensitivity information indicating an amplitude of pressure sensitivity of contact between the electronic stamping device and the touchscreen; and
an adjusting unit for adjusting depths of color of the stamping image displaying at the stamping position based on the pressure sensitivity information.
